(19) United States
(12) Patent Application Publication
(10) Pub. No.: US 2023/0401359 A1
(43) Pub. Date: Dec. 14, 2023

(54) METHOD FOR OPTIMIZING WEIGHT OF DISC SPRING

(71) Applicant: Wenzhou University, Zhejiang (CN)

(72) Inventors: Pengjun WANG, Zhejiang (CN); Shiming Song, Zhejiang (CN); Yijian SHI, Zhejiang (CN)

(73) Assignee: Wenzhou University, Zhejiang (CN)

(21) Appl. No.: 18/331,893

(22) Filed: Jun. 8, 2023

(30) Foreign Application Priority Data
Jun. 9, 2022 (CN) 202210643552.9

(51) Int. Cl. G06F 30/20; G06F 17/11; G06F 30/17

(52) U.S. Cl. CPC G06F 30/20; G06F 17/11; G06F 30/17

(57) ABSTRACT

A method for optimizing a weight of a disc spring includes: determining an objective function for weight optimization of the disc spring and key parameters to be solved; optimizing an original Harris Hawks optimization structure, specifically including: first, eliminating steps of centralized calculation of objective function values of the original Harris Hawks optimization except a step of population initialization, and recording a result when a better solution is obtained; second, introducing a random unit permutation mechanism before an end of each iterative optimization of the original Harris Hawks optimization; third, deleting a step of searching for an energy factor E with an absolute value greater than or equal to 1; and solving the key parameters by means of the optimized Harris Hawks optimization referred to as the random unit permutation-based Harris Hawks optimization to obtain the key parameters for weight optimization of the disc spring.

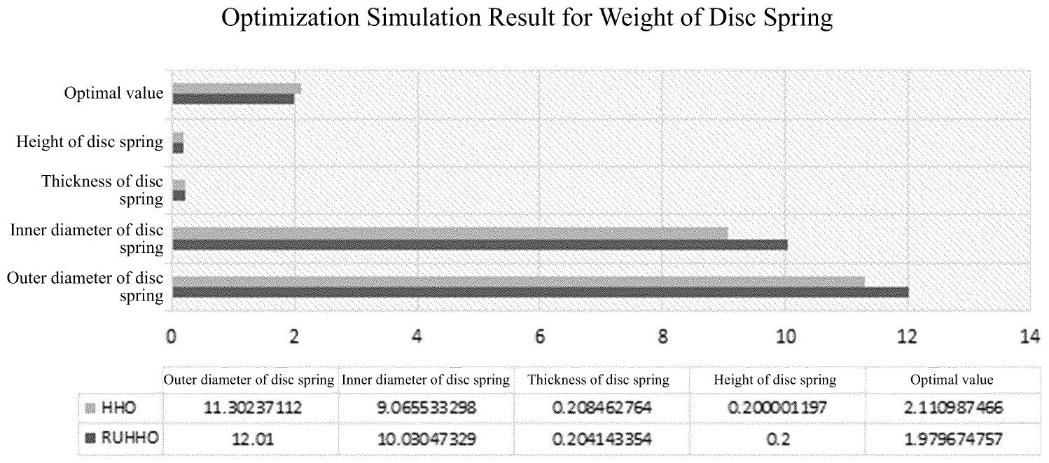

### CROSS-REFERENCE TO RELATED APPLICATION

This application claims the priority benefit of China application serial no. 202210643552.9, filed on Jun. 9, 2022. The entirety of the above-mentioned patent application is hereby incorporated by reference herein and made a part of this specification.

### BACKGROUND

### Technical Field

The invention relates to an optimization method, in particular to a method for optimizing a weight of a disc spring.

### Description of Related Art

Disc springs, which are similar to discs in shape and have a good shock-absorption capacity, are widely applied to the elastic suspensions of vehicles, or are used in scenarios requiring shock insulation. The load and deformation of the disc springs are in a nonlinear relation, and the load-deformation curve of the disc springs varies accordingly with the ratio of the height of an inner frustum to the thickness of a steel spring plate. In actual application, the weight of the disc springs needs to be optimized. Weight optimization of the disc springs is regarded as an optimization problem with complex constraints due to its complex mathematical properties and constraints.

Traditionally, this problem is solved through a mathematical method, which excessively relies on the mathematical properties of an optimization model, so when the complexity of the optimization model increases, the solving precision and speed will be reduced, and even the problem cannot be solved. Harris Hawks optimization, as a novel meta-heuristic algorithm proposed in recent years, can effectively overcome the drawbacks of the traditional mathematical method. Harris Hawks optimization is not concerned about the specific mathematical properties of the optimization model and has the advantages of using less parameters, high universality, and the like, thus being widely applied to the optimization field. However, since Harris Hawks optimization is not proposed for weight optimization of disc springs, it has some defects when used for weight optimization of disc springs. First, when Harris Hawks optimization runs, an objective function will be called repeatedly to adjust the search direction of the algorithm, so the objective function at the same position has to be called multiple times, leading to the waste of computation resources; second, the randomness of Harris Hawks optimization during global search is excessively high, leading to a low convergence rate; and finally, due to the insufficient convergence of Harris Hawks optimization during local search, the solving precision of this algorithm is excessively low.

### SUMMARY

The technical issue to be settled by the invention is to provide a method for optimizing a weight of a disc spring, which is high in convergence rate and solving precision. According to the method for optimizing the weight of the disc spring, a random unit permutation mechanism is introduced to original Harris Hawks optimization to optimize the Harris Hawks optimization structure to obtain a random unit permutation-based Harris Hawks optimization, which is used to extract key parameters for weight optimization of the disc spring, such that the solving speed and the optimization precision are further improved, optimal parameters are finally solved under the precondition of meeting constraints, and the structural weight of the disc spring is optimized.

The technical solution adopted by the invention to settle the above technical issue is as follows: a method for optimizing the weight of the disc spring comprises the following steps:
S1: determining an objective function for weight optimization of the disc spring and key parameters to be solved; and
S2: optimizing an original Harris Hawks optimization structure, specifically: first, eliminating steps of centralized calculation of objective function values in the original Harris Hawks optimization except a step of population initialization, and recording a result when a better solution is obtained, to save the calculation time; second, introducing a random unit permutation mechanism before the end of each iterative optimization of the original Harris Hawks optimization to enhance the global search performance; third, deleting a step of searching for an energy factor E with an absolute value greater than or equal to 1 of the original Harris Hawks optimization to reduce the influence of the random unit permutation mechanism on the optimization effect; referring to the optimized Harris Hawks optimization as random unit permutation-based Harris Hawks optimization, and solving the key parameters by means of the random unit permutation-based Harris Hawks optimization to obtain the key parameters for weight optimization of the disc spring;
Wherein determining the objective function for weight optimization of the disc spring and the key parameters to be solved in S1 specifically comprises:
S1.1: determining the objective function for weight optimization of the disc spring, wherein the objective function is shown by formula (1):

$$F ( x ) = ρ {V}_{B S} = ρ \cdot \frac{π}{4} \cdot ( {D}_{ot}^{t} - {D}_{i n n}^{2} ) {t}_{s} \qquad ( 1 )$$

Where F(x) is the objective function and represents a weight of the disc spring, which is measured by pound (lb); ρ represents a density of the disc spring, which is measured by pound/cubic inch (lb/in³); V_{BS} is a size of the disc spring, which is measured by cubic inch (in³); π is a circular constant; Dₒₜ is an outer diameter of the disc spring, which is measured by inch (in); Dᵢₙₙ is an inner diameter of the disc spring, which is measured by inch (in); tₛ is a thickness of the disc spring, which is measured by inch (in);
S1.2: determining constraints for weight optimization of the disc spring, wherein the constraints are shown by formula (2) to formula (8):

$${g}_{1} ( x ) = S - \frac{4 E {δ}_{max}}{( 1 - {μ}^{2} ) α {D}_{ot}^{2}} [ β ( h - \frac{{δ}_{max}}{2} ) + γ {t}_{s} ] \geq 0 \qquad ( 2 )$$

$${g}_{2} ( x ) = \frac{4 E {δ}_{max}}{( 1 - {μ}^{2} ) α {D}_{ot}^{2}} [ ( h - \frac{{δ}_{max}}{2} ) ( h - {δ}_{max} ) {t}_{s} + {t}_{s}^{3} ] - {P}_{max} \geq 0 \qquad ( 3 )$$

$${g}_{3} ( x ) = {δ}_{l} - {δ}_{max} \geq 0 \qquad ( 4 )$$

$${g}_{4} ( x ) = H - h - {t}_{s} \geq 0 \qquad ( 5 )$$

$${g}_{5} ( x ) = {D}_{max} - {D}_{ot} \geq 0 \qquad ( 6 )$$

$${g}_{6} ( x ) = {D}_{ot} - {D}_{i n n} \geq 0 \qquad ( 7 )$$

$${g}_{7} ( x ) = 0.3 - \frac{h}{{D}_{o t} - {D}_{i n n}} \geq 0 \qquad ( 8 )$$

Where g₁(x) is a stress constraint induced by radial compression of the disc spring, g₂(x) is a rigidity constraint of the disc spring, g₃(x) is a limited deflection constraint of the disc spring, g₄(x) is a thickness-height relation constraint of the disc spring, g₅(x) is an outer diameter constraint of the disc spring, g₆(x) is an outer diameter-inner diameter relation constraint of the disc spring, and g₇(x) is a geometric size constraint of the disc spring, h represents the height of the disc spring, which is measured by inch (in); S represents allowable strength of the disc spring, which is measured by kilopound/square inch (kpsi); E represents an elastic modulus of the disc spring, which is measured by pound/square inch (psi); δₘₐₓ represents the maximum deflection of the disc spring, which is measured by inch (in); μ is a Poisson's ratio of the disc spring; Pₘₐₓ represents a maximum load of the disc spring, which is measured by pound (lb); H is a maximum limit of the height of the disc spring, which is measured by inch (in); Dₘₐₓ is a maximum outer diameter of the disc spring, which is measured by inch (in); δₗ is limited deflection, δₗ=f(a)h;

$$a = \frac{h}{{t}_{s}}$$

represents a ratio of the height of the disc spring to the thickness of the disc spring; f(a) represents load deformation of the disc spring, which is measured by inch (in); K=Dₒₜ/Dᵢₙₙ, and α, β and γ are temporary variables and are calculated by formula (9) to formula (11):

$$α = \frac{6}{π lnK} ( \frac{K - 1}{K} ) \qquad ( 9 )$$

$$β = \frac{6}{π lnK} ( \frac{K - 1}{lnK} - 1 ) \qquad ( 10 )$$

$$γ = \frac{6}{π lnK} ( \frac{K - 1}{2} ) \qquad ( 11 )$$

S1.3: determining parameter values in the constraints shown by formula (2) to formula (8), where ρ=0.283 lb/in³, S=200 kpsi, E=30×10⁶ psi, δₘₐₓ=0.2 in, μ=0.3, Pₘₐₓ=5400 lb, H=2 in, Dₘₐₓ=12.01 in, and the relation between a and f(a) is as follows: when a<1.45, f(a)=1; when 1.45≤a<1.55, f(a)=0.85; when 1.55≤a<1.65, f(a)=0.77; when 1.65≤a<1.75, f(a)=0.71; when 1.75≤a<1.85, f(a)=0.66; when 1.85≤a<1.95, f(a)=0.63; when 1.95≤a<2.05, f(a)=0.6; when 2.05≤a<2.15, f(a)=0.58; when 2.15≤a<2.25, f(a)=0.56; when 2.25≤a<2.35, f(a)=0.55; when 2.35≤a<2.45, f(a)=0.53; when 2.45≤a<2.55, f(a)=0.52; when 2.55≤a<2.65, f(a)=0.51; when 2.65≤a<2.75, f(a)=0.51; when a≥2.75, f(a)=0.50; the remaining four parameters, namely the outer diameter Dₒₜ of the disc spring, the inner diameter Dᵢₙₙ of the disc spring, the thickness tₛ of the disc spring, and the height h of the disc spring, are the key parameters to be solved, and meet: 5 in≤Dₒₜ≤15 in, 5 in≤Dᵢₙₙ≤15 in, 0.01 in≤tₛ≤6 in, and 0.05 in≤h≤0.5 in; the key parameters to be solved are represented by a vector X, where a lower bound of X is represented by a vector LB, an upper bound of X is represented by a vector UB, and X, LB and UB are expressed by formula (12) to formula (14):

X=[Dₒₜ,Dᵢₙₙ,tₛ,h] (12)

LB=[5,5,0.01,0.05] (13)

UB=[15,15,6,0.5] (14)
Where first-dimensional data of LB represents a lower bound of Dₒₜ, second-dimensional data of LB represents a lower bound of Dᵢₙₙ, third-dimensional data of LB represents a lower bound of tₛ, fourth-dimensional data of LB represents a lower bound of h, first-dimensional data of UB represents an upper bound of Dₒₜ, second-dimensional data of UB represents an upper bound of third-dimensional data of UB represents an upper bound of tₛ, and fourth-dimensional data of UB represents an upper bound of h; and
S1.4: transforming the objective function shown by formula (1) with the vector X to obtain a final objective function which is expressed by formula (15):

F(X)=0.07075π((X¹)²−(X²)²)X³ (15)
Where X¹ represents first-dimensional data of the vector X, X² represents second-dimensional data of the vector X, X³ represents third-dimensional data of the vector X, and (·) 2 represents a square operation of data, that is, (X¹)₂ represents a square operation of X¹, and (X²)₂ represents a square operation of X²;
Solving the key parameters by means of the random unit permutation-based Harris Hawks optimization to obtain the key parameters for weight optimization of the disc spring in S2 specifically comprises:
S2.1: performing population initialization to obtain an initial population: making the vector X correspond to individuals of a population, wherein the individuals have four dimensions, first-dimensional data of the individuals corresponds to Dₒₜ, second-dimensional data of the individuals corresponds to Dᵢₙₙ, third-dimensional data of the individuals corresponds to tₛ, and fourth-dimensional data of the individuals corresponds to h; setting a population capacity N corresponding to the random unit permutation-based Harris Hawks optimization to 30, randomly initializing 30 individuals according to formula (16) to obtain the initial population:

$$\begin{matrix}Pop = \begin{matrix}[ \begin{matrix}{LB}_{1}^{1} & … & {LB}_{1}^{0} \\ ⋮ & … & ⋮ \\ {LB}_{N}^{1} & … & {LB}_{N}^{D}\end{matrix} ] + \\ [ \begin{matrix}{rand}_{1}^{1} & … & {rand}_{1}^{D} \\ ⋮ & … & ⋮ \\ {rand}_{N}^{1} & … & {rand}_{N}^{D}\end{matrix} ] ∘ [ \begin{matrix}{UB}_{1} - {LB}_{1} \\ ⋮ \\ {UB}_{N} - {LB}_{N}\end{matrix} ]\end{matrix} \\ = [ \begin{matrix}{X}_{1}^{1} & … & {X}_{1}^{D} \\ ⋮ & … & ⋮ \\ {X}_{N}^{1} & … & {X}_{N}^{D}\end{matrix} ] = [ \begin{matrix}{X}_{1} \\ ⋮ \\ {X}_{N}\end{matrix} ]\end{matrix} \qquad ( 16 )$$

Where LBᵢᵢ^{j} represents a lower bound of j^{th}-dimensional data of the (ii)^{th} individual; randᵢᵢ^{j} represents the j^{th}-dimensional data of the (ii)^{th} individual generated by a random function, which is within [0,1]; ° represents a Hadmard product operator of a matrix, that is, elements at the same position of the matrix are multiplied; UBᵢᵢ=UB, LBᵢᵢ=LB, and Xᵢᵢ represents the (ii)^{th} individual of the initial population; Xᵢᵢ=[Xᵢᵢ¹, Xᵢᵢ², Xᵢᵢ³, Xᵢᵢ⁴], Xᵢᵢ^{j} represents the j^{th}-dimensional data of the (ii)^{th} individual, ii=1, 2, . . . , 30, and j=1, 2, 3, 4;
S2.2: evaluating the initial population: calculating an objective function value of each individual in the initial population according to the objective function shown by formula (15), and determining each individual in the initial population according to the constraints in formula (2) to formula (8); if the current individual fails to meet all the constraints, updating this individual by randomly reassigning each of the dimensional data, within a range of the upper bound and the lower bound corresponding to each of the dimensional data, of the individual, and after the current individual is updated, directly setting the objective function value of this individual to 10¹⁰ rather than calculating the objective function value of this individual by formula (15); if the current individual meets all the constraints, keeping this individual unchanged, such that a 0-generation population is obtained; denoting the individual having a minimum objective function value among all individuals meeting all the constraints in the 0-generation population as gBest, denoting the objective function value of the individual gBest as F(gBest), setting a global optimal individual of the (ii)^{th} individual, and denoting the global optimal individual of the (ii)^{th} individual as pBestᵢᵢ; initializing the value of pBestᵢᵢ with Xᵢᵢ in the 0-generation population, and denoting an objective function value of pBestᵢᵢ as F(pBestᵢᵢ);
S2.3: setting an iteration variable t, a maximum iteration T, initializing the iteration variable t to 1, and setting the maximum iteration T to 1000;
S2.4: performing a t^{th} iteration on the population to obtain a t-generation population, which specifically comprises:
S2.4.1: setting an individual number i, and initializing the individual number i to 1;
S2.4.2: updating an i^{th} individual to obtain the i^{th} individual Xᵢ(t) of the t-generation population, which specifically comprises:
S2.4.2.1: setting an energy factor for the t^{th} iteration of the i^{th} individual, and calculating the energy factor for the t^{th} iteration of the i^{th} individual, which is used for switching a search mode of the algorithm:

$${E}_{f}^{{t}^{i}} = 2 {E}_{0}^{{t}^{i}} \cdot ( 1 - \frac{t}{T} ) \qquad ( 17 )$$

Where E₀^{t}^{ⁱ} represents a random number for the t^{th} iteration of the i^{th} individual and is generated by a random function, −1≤E₀^{t}^{ⁱ}≤1;
S2.4.2.2: if |E_{f}^{t}^{ⁱ}|<1, performing S2.4.2.3; if |E_{f}^{t}^{ⁱ}|≥1, setting the value of Xᵢ(t) to Xᵢ(t−1), then performing S2.4.2.4, where Xᵢ(t−1) is an i^{th} individual of a (t−1)-generation population, and | | is an absolute value sign;
S2.4.2.3: generating a random number q^{t}^{ⁱ} by the random function, wherein 0≤q^{t}^{ⁱ}≤1; if q^{t}^{ⁱ}≥0.5 and |E_{f}^{t}^{ⁱ}|≥0.5, updating the i^{th} individual according to formula (18) to obtain Xᵢ(t); if q^{t}^{ⁱ}<0.5 and |E_{f}^{t}^{ⁱ}|≥0.5, updating the i^{th} individual according to formula (23) to obtain Xᵢ(t); if q^{t}^{ⁱ}≥0.5 and |E_{f}^{t}^{ⁱ}|<0.5, updating the i^{th} individual according to formula (24) to obtain Xᵢ(t); if q^{t}^{ⁱ}<0.5 and |E_{f}^{t}^{ⁱ}|<0.5, updating the i^{th} individual according to formula (28) to obtain Xᵢ(t); after Xᵢ(t) is obtained according to formula (18), (23), (24) or (28), calculating an objective function value of Xᵢ(t) according to formula (15); if the objective function value of Xᵢ(t) is less than an objective function value of Xᵢ(t−1), remaining Xᵢ(t) unchanged; if the objective function value of Xᵢ(t) is greater than the objective function value of Xᵢ(t−1), updating Xᵢ(t) to Xᵢ(t−1), substituting data of Xᵢ(t) into formula (2) to formula (8), and determining whether Xᵢ(t) meets the constraints in formula (2) to formula (8); if so, remaining Xᵢ(t) unchanged; otherwise, updating Xᵢ(t) again, reassigning each of the dimensional data, within a range of the upper bound and the lower bound corresponding to each of the dimensional data, of Xᵢ(t), and after Xᵢ(t) is updated, directly setting the objective function value F(Xᵢ(t)) of Xᵢ(t) to 10¹⁰ rather than calculating the objective function value F(Xᵢ(t)) according to formula (15);

$${X}_{i} ( t ) = gBest - {X}_{i} ( t - 1 ) - {E}_{f}^{{t}^{i}} \vert ( {J}^{{t}^{i}} \cdot gBest - {X}_{i} ( t - 1 ) ) \vert \qquad ( 18 )$$

$${J}^{{t}^{i}} = 2 ( 1 - {r}_{1}^{{t}^{i}} ) \qquad ( 19 )$$

$${A}^{{t}^{i}} = gBest - {E}_{f}^{{t}^{i}} \vert {J}^{{t}^{i}} \cdot gBest - {X}_{i} ( t - 1 ) \vert \qquad ( 20 )$$

$${B}^{{t}^{i}} = {A}^{{t}^{i}} + {R}^{{t}^{i} ∘} L F ( D ) \qquad ( 21 )$$

$$LF ( D ) = \frac{{r}_{2}^{{r}^{i}} \times σ}{{\vert {r}_{3}^{{t}^{i}} \vert}^{θ}} , σ = {( \frac{Γ ( 1 + θ ) \times sin ( \frac{π θ}{2} )}{Γ ( \frac{1 + θ}{2} ) \times θ \times 2 ( \frac{θ - 1}{2} )} )}^{\frac{1}{θ}} \qquad ( 22 )$$

$${X}_{i} ( t ) = \{ \begin{matrix}{A}^{{t}^{i}} & if F ( {A}^{{t}^{i}} ) < F ( {B}^{{t}^{i}} ) \\ {B}^{{t}^{i}} & if F ( {A}^{{t}^{i}} ) \geq F ( {B}^{{t}^{i}} )\end{matrix} \qquad ( 23 )$$

$${X}_{i} ( t ) = gBest - {E}_{f}^{{t}^{i}} \vert gBest - {X}_{i} ( t - 1 ) \vert \qquad ( 24 )$$

$${Y}^{{t}^{i}} = gBest - {E}_{f}^{{t}^{i}} \vert {J}^{{t}^{i}} \cdot gBest - {Mean}^{{t}^{i}} \vert \qquad ( 25 )$$

$${Mean}^{{t}^{i}} = \frac{1}{N} {\sum }_{n u m = 1}^{N} {X}_{n u m} ( t - 1 ) \qquad ( 26 )$$

$${Z}^{{t}^{i}} = {Y}^{{t}^{i}} + {R}^{{t}^{i} ∘} L F ( D ) \qquad ( 27 )$$

$${X}_{i} ( t ) = \{ \begin{matrix}{Y}^{{t}^{i}} & if F ( {Y}^{{t}^{i}} ) < F ( {Z}^{{t}^{i}} ) \\ {Z}^{{t}^{i}} & if F ( {Y}^{{t}^{i}} ) \geq F ( {Z}^{{t}^{i}} )\end{matrix} \qquad ( 28 )$$

Where Xᵢ(t) represents the i^{th} individual of the t-generation population, A^{t}^{ⁱ}, B^{t}^{ⁱ}, Y^{t}^{ⁱ}, Z^{t}^{ⁱ} represent four intermediate individuals generated for the i^{th} individual during the t^{th} iteration, | | represents an absolute value sign, the value of 0 is 1.5, r₁^{t}^{ⁱ} represents a first one-row D-dimensional random number vector generated for the i^{th} individual by the t^{th} iteration, each of the dimensional data of the first one-row D-dimensional random number vector has a lower bound 0 and an upper bound 1, r₂^{t}^{ⁱ} represents a second one-row D-dimensional random number vector generated for the i^{th} individual by the t^{th} iteration, each of the dimensional data of the second one-row D-dimensional random number vector has a lower bound 0 and an upper bound 1, represents a third one-row D-dimensional random number vector generated for the i^{th} individual by the t^{th} iteration, each of the dimensional data of the third one-row D-dimensional random number vector has a lower bound 0 and an upper bound 1, J^{t}^{ⁱ} represents a random number generated for the i^{th} individual by the t^{th} iteration and is used for disturbing a current optimal individual to improve the diversity of the population, LF is a levy flight function, Mean^{t}^{ⁱ} represents a mean value of Xᵢ(t−1), X₂(t−1), . . . , X_{N}(t−1) when the i^{th} individual is solved by the t^{th} iteration, and is expressed by formula (26), Γ is a gamma function, R^{t}^{ⁱ} represents the one-column D-dimensional random number vector generated for i^{th} individual by the t^{th} iteration, and each of the dimensional data of the one-column D-dimensional random number vector has a lower bound 0 and an upper bound 1; if the objective function value F(Xᵢ(t)) of Xᵢ(t) is set to 10¹⁰, the objective function value F(Xᵢ(t)) of Xᵢ(t) is obtained directly; if the objective function value F(Xᵢ(t)) of Xᵢ(t) is not set to 10¹⁰, the objective function value F(Xᵢ(t)) of Xᵢ(t) is calculated according to formula (15); then, if F(Xᵢ(t))<F(gBest), a variable value of gBest is updated to Xᵢ(t); otherwise, the variable value of gBest is not updated; if F(Xᵢ(t))<F(pBestᵢ), a variable value of pBestᵢ is updated to Xᵢ(t); otherwise, the variable value of pBestᵢ is not updated; up to now, Xᵢ(t) is updated, and S2.4.2.4 is performed;
S2.4.2.4: setting four intermediate individuals M1^{t}^{ⁱ}, M2^{t}^{ⁱ}, SM1^{t}^{ⁱ} and SM2^{t}^{ⁱ}, and calculating M1^{t}^{ⁱ} and M2^{t}^{ⁱ} according to formula (29) and formula (30);

$$M {1}^{{t}^{i}} = {k}_{1}^{{t}^{i}} \cdot ( {k}_{2}^{{t}^{i}} \cdot {X}_{{a}_{1}^{{t}^{i}}} ( t - 1 ) + ( \sim {k}_{2}^{{t}^{i}} ) \cdot {X}_{{a}_{2}^{{t}^{i}}} ( t - 1 ) ) + ( \sim {k}_{1}^{{t}^{i}} ) \cdot gBest \qquad ( 29 )$$

$$M {2}^{{t}^{i}} = {k}_{1}^{{t}^{i}} \cdot ( {k}_{2}^{{t}^{i}} \cdot {X}_{{a}_{3}^{{t}^{i}}} ( t - 1 ) + ( \sim {k}_{2}^{{t}^{i}} ) \cdot {X}_{{a}_{4}^{{t}^{i}}} ( t - 1 ) ) + ( \sim {k}_{1}^{{t}^{i}} ) \cdot gBest \qquad ( 30 )$$

Where k₁^{t}^{ⁱ} is a one-row D-dimensional random number vector generated by the random function, and each of the dimensional data of the one-row D-dimensional random number vector has a lower bound 0 and an upper bound 1; k₂^{t}^{ⁱ} is a one-row D-dimensional random number vector generated by the random function, and each of the dimensional data of the one-row D-dimensional random number vector has a lower bound 0 and an upper bound 1; ˜ is a bitwise negation operator; the values of a₁^{t}^{ⁱ}, a₂^{t}^{ⁱ}, a₃^{t}^{ⁱ}, a₄^{t}^{ⁱ} are four different integers within [1, N] except i;
Substituting M1^{t}^{ⁱ} and M2^{t}^{ⁱ} into formula (31) and formula (32) respectively to obtain SM1^{t}^{ⁱ} and SM2^{t}^{ⁱ}:

$$SM {1}^{{t}^{i}} = M {1}^{{t}^{i}} + 2 \cdot {r}_{4}^{{t}^{i}} \cdot {e}^{F ( g Best ) - F ( {X}_{i} ( t ) ) ∘} ( gBest - {X}_{i} ( t - 1 ) ) + {r}_{5}^{{t}^{i} ∘} ( gBest - pBes {t}_{i} ) \qquad ( 31 )$$

$$SM {2}^{{t}^{i}} = M {2}^{{t}^{i}} + 2 \cdot {r}_{6}^{{t}^{i}} \cdot {e}^{g Best - {X}_{i} ( t ) ∘} ( gBest - {X}_{i} ( t ) ) + {r}_{7}^{{t}^{i}} \cdot ( gBest - {X}_{i} ( t - 1 ) ) \qquad ( 32 )$$

Where r₄^{t}^{ⁱ} a one-row D-dimensional random number vector generated by the random function, and each of the dimensional data of the one-row D-dimensional random number vector has a lower bound 0 and an upper bound 1; r₅^{t}^{ⁱ} is a one-row D-dimensional random number vector generated by the random function, and each of the dimensional data of the one-row D-dimensional random number vector has a lower bound 0 and an upper bound 1; r₆^{t}^{ⁱ} is a random number generated by the random function, and −1≤r₆^{t}^{ⁱ}≤1; r₇^{t}^{ⁱ} is a random function generated by the random function, and −1≤r₇^{t}^{ⁱ}≤1; r₇^{t}^{ⁱ} is a Napierian constant, the value of e is 2.718281828459045;
Substituting data of SM1^{t}^{ⁱ} and data of SM2^{t}^{ⁱ} into formula (2) and formula (8) respectively; determining whether SM1^{t}^{ⁱ} and SM2^{t}^{ⁱ} meet the constraints in formula (2) to formula (8); if either SM1^{t}^{ⁱ} or SM2^{t}^{ⁱ} fails to meet all the constraints, updating the intermediate individual (SM1^{t}^{ⁱ} or SM2^{t}^{ⁱ}) not meeting all the constraints, and reassigning each of the dimensional data, between a range of the upper bound and the lower bound corresponding to each of the dimensional data, of the individual, and directly setting an objective function value of this individual to 10¹⁰, which is then substituted into formula (33) to obtain an intermediate individual Q^{t}^{ⁱ}; if SM1^{t}^{ⁱ} and SM2^{t}^{ⁱ} both meet all the constraints, directly substituting SM1^{t}^{ⁱ} and SM2^{t}^{ⁱ} into formula (33) to obtain the intermediate individual Q^{t}^{ⁱ}.

$${Q}^{{t}^{i}} = \{ \begin{matrix}S M {1}^{{t}^{i}} , & if F ( S M {1}^{{t}^{i}} ) < F ( S M {2}^{{t}^{i}} ) \\ S M {2}^{{t}^{i}} , & else\end{matrix} \qquad ( 33 )$$

S2.4.2.5: updating Xᵢ(t) to Q^{t}^{ⁱ}; calculating the objective function value of Xᵢ(t) according to formula (15); if the objective function value of Xᵢ(t) is less than the objective function value of gBest, updating the objective function value of gBest to Xᵢ(t); otherwise, not updating the objective function value of gBest; if the objective function of Xᵢ(t) is less than the objective function value of pBestᵢ, updating pBestᵢ to Xᵢ(t); otherwise, not updating pBestᵢ;
S2.4.3: determining whether a current value of i is equal to N; if the current value of i is not equal to N, updating the current value of i to the sum of the current value of i and 1, and then returning to S2.4.2 to update the next individual; if the current value of i is equal to N, completing the t^{th} iteration to obtain N individuals X₁(t) to X_{N}(t) of the t-generation population, and performing the next step;
S2.4.4: determining whether a current value of t is equal to T; if the current value of t is not equal to T, updating the current value of t to the sum of the current value of t and 1, and then returning to S2.4 to perform the next iteration; if the current value of t is equal to T, performing the next step; and
S2.5: outputting the current gBest, and using the current gBest as the key parameters for weight optimization of the disc spring.

Compared with the prior art, the invention has the following beneficial effects: after an objective function for weight optimization of a disc spring and key parameters to be solved are determined, an original Harris Hawks optimization structure is optimized specifically as follows: first, steps of centralized calculation of objective function values of the original Harris Hawks optimization except a step of population initialization are eliminated, and a result is recorded when a better solution is obtained, to save the calculation time; second, a random unit permutation mechanism is introduced before the end of each iterative optimization of the original Harris Hawks optimization to enhance the global search performance; third, a step of searching for an energy factor E with an absolute value greater than or equal to 1 of the original Harris Hawks optimization is deleted to reduce the influence of the random unit permutation mechanism on the optimization effect; the optimized Harris Hawks optimization is referred to as a random unit permutation-based Harris Hawks optimization, and key parameters are solved by means of the random unit permutation-based Harris Hawks optimization to obtain the key parameters for weight optimization of the disc spring; in the invention, the random unit permutation-based Harris Hawks optimization is not concerned about the specific mathematical properties of an optimization model, and thus effectively avoids being trapped in local extrema; running of the random unit permutation-based Harris Hawks optimization is limited by the number of iterations, and the resolving time is controllable, so excessively long computation time is prevented; the random unit permutation-based Harris Hawks optimization adopts the random unit permutation mechanism to improve the diversity of populations, so the solving speed and precision are further improved; and the original Harris Hawks optimization structure is optimized to ensure the introduced mechanism to fulfill the optimal effect, so the method has high convergence rate and solving precision, can further optimize the weight of disc springs, and has high application value.

### BRIEF DESCRIPTION OF THE DRAWINGS

FIGURE illustrates the simulation results of a method for optimizing a weight of a disc spring according to the invention.

### DESCRIPTION OF THE EMBODIMENTS

The invention will be described in further detail below in conjunction with the accompanying drawing and embodiments.

Embodiment: a method for optimizing a weight of a disc spring comprises the following steps:
S1: determining an objective function for weight optimization of the disc spring and key parameters to be solved; and
S2: optimizing an original Harris Hawks optimization structure, specifically: first, eliminating steps of centralized calculation of objective function values in the original Harris Hawks optimization except a step of population initialization, and recording a result when a better solution is obtained, to save the calculation time; second, introducing a random unit permutation mechanism before the end of each iterative optimization of the original Harris Hawks optimization to enhance the global search performance; third, deleting a step of searching for an energy factor E with an absolute value greater than or equal to 1 of the original Harris Hawks optimization to reduce the influence of the random unit permutation mechanism on the optimization effect; referring to the optimized Harris Hawks optimization as random unit permutation-based Harris Hawks optimization, and solving the key parameters by means of the random unit permutation-based Harris Hawks optimization to obtain the key parameters for weight optimization of the disc spring.

In this embodiment, determining the objective function for weight optimization of the disc spring and the key parameters to be solved in S1 specifically comprises:
S1.1: determining the objective function for weight optimization of the disc spring, wherein the objective function is shown by formula (1):

$$F ( x ) = ρ {V}_{B S} = ρ \cdot \frac{π}{4} \cdot ( {D}_{ot}^{t} - {D}_{i n n}^{2} ) {t}_{s} \qquad ( 1 )$$

Where, F(x) is the objective function and represents a weight of the disc spring, which is measured by pound (lb); ρ represents a density of the disc spring, which is measured by pound/cubic inch (lb/in³); V_{BS} is a size of the disc spring, which is measured by cubic inch (in³); π is a circular constant; Dₒₜ is an outer diameter of the disc spring, which is measured by inch (in); Dᵢₙₙ is an inner diameter of the disc spring, which is measured by inch (in); tₛ is a thickness of the disc spring, which is measured by inch (in);
S1.2: determining constraints for weight optimization of the disc spring, wherein the constraints are shown by formula (2) to formula (8):

$${g}_{1} ( x ) = S - \frac{4 E {δ}_{max}}{( 1 - {μ}^{2} ) α {D}_{ot}^{2}} [ β ( h - \frac{{δ}_{max}}{2} ) + γ {t}_{s} ] \geq 0 \qquad ( 2 )$$

$${g}_{2} ( x ) = \frac{4 E {δ}_{max}}{( 1 - {μ}^{2} ) α {D}_{ot}^{2}} [ ( h - \frac{{δ}_{max}}{2} ) ( h - {δ}_{max} ) {t}_{s} + {t}_{s}^{3} ] - {P}_{max} \geq 0 \qquad ( 3 )$$

$${g}_{3} ( x ) = {δ}_{l} - {δ}_{max} \geq 0 \qquad ( 4 )$$

$${g}_{4} ( x ) = H - h - {t}_{s} \geq 0 \qquad ( 5 )$$

$${g}_{5} ( x ) = {D}_{max} - {D}_{ot} \geq 0 \qquad ( 6 )$$

$${g}_{6} ( x ) = {D}_{ot} - {D}_{i n n} \geq 0 \qquad ( 7 )$$

$${g}_{7} ( x ) = 0.3 - \frac{h}{{D}_{o t} - {D}_{i n n}} \geq 0 \qquad ( 8 )$$

g₁(x) is a stress constraint induced by radial compression of the disc spring, g₂(x) is a rigidity constraint of the disc spring, g₃(x) is a limited deflection constraint of the disc spring, g₄(x) is a thickness-height relation constraint of the disc spring, g₅(x) is an outer diameter constraint of the disc spring, g₆(x) is an outer diameter-inner diameter relation constraint of the disc spring, and g₇(x) is a geometric size constraint of the disc spring, h represents the height of the disc spring, which is measured by inch (in); S represents allowable strength of the disc spring, which is measured by kilopound/square inch (kpsi); E represents an elastic modulus of the disc spring, which is measured by pound/square inch (psi); δₘₐₓ represents the maximum deflection of the disc spring, which is measured by inch (in); μ is a Poisson's ratio of the disc spring; Pₘₐₓ represents a maximum load of the disc spring, which is measured by pound (lb); H is a maximum limit of the height of the disc spring, which is measured by inch (in); Dₘₐₓ is a maximum outer diameter of the disc spring, which is measured by inch (in); δₗ is limited deflection, δₗ=f(a)h;

$$a = \frac{h}{{t}_{s}}$$

represents a ratio of the height of the disc spring to the thickness of the disc spring; f(a) represents load deformation of the disc spring, which is measured by inch (in); K=Dₒₜ/Dᵢₙₙ, and α, β and γ are temporary variables and are calculated by formula (9) to formula (11):

$$α = \frac{6}{π lnK} ( \frac{K - 1}{K} ) \qquad ( 9 )$$

$$β = \frac{6}{π lnK} ( \frac{K - 1}{lnK} - 1 ) \qquad ( 10 )$$

$$γ = \frac{6}{π lnK} ( \frac{K - 1}{2} ) \qquad ( 11 )$$

S1.3: determining parameter values in the constraints shown by formula (2) to formula (8), where ρ=0.283 lb/in³, S=200 kpsi, E=30×10⁶ psi, δₘₐₓ=0.2 in, μ=0.3, Pₘₐₓ=5400 lb, H=2 in, Dₘₐₓ=12.01 in, and the relation between a and f(a) is as follows: when a<1.45, f(a)=1; when 1.45≤a<1.55, f(a)=0.85; when 1.55≤a<1.65, f(a)=0.77; when 1.65≤a<1.75, f(a)=0.71; when 1.75≤a<1.85, f(a)=0.66; when 1.85≤a<1.95, f(a)=0.63; when 1.95≤a<2.05, f(a)=0.6; when 2.05≤a<2.15, f(a)=0.58; when 2.15≤a<2.25, f(a)=0.56; when 2.25≤a<2.35, f(a)=0.55; when 2.35≤a<2.45, f(a)=0.53; when 2.45≤a<2.55, f(a)=0.52; when 2.55≤a<2.65, f(a)=0.51; when 2.65≤a<2.75, f(a)=0.51; when a≥2.75, f(a)=0.50; the remaining four parameters, namely the outer diameter Dₒₜ of the disc spring, the inner diameter Dᵢₙₙ of the disc spring, the thickness tₛ of the disc spring, and the height h of the disc spring, are the key parameters to be solved, and meet: 5 in≤Dₒₜ≤15 in, 5 in≤Dᵢₙₙ≤15 in, 0.01 in≤tₛ≤6 in, and 0.05 in≤h≤0.5 in; the key parameters to be solved is represented by a vector X, where a lower bound of X is represented by a vector LB, an upper bound of X is represented by a vector UB, and X, LB and UB are expressed by formula (12) to formula (14):

X=[Dₒₜ,Dᵢₙₙ,tₛ,h] (12)

LB=[5,5,0.01,0.05] (13)

UB=[15,15,6,0.5] (14)
Where first-dimensional data of LB represents a lower bound of Dₒₜ, second-dimensional data of LB represents a lower bound of Dᵢₙₙ, third-dimensional data of LB represents a lower bound of tₛ, fourth-dimensional data of LB represents a lower bound of h, first-dimensional data of UB represents an upper bound of Dₒₜ, second-dimensional data of UB represents an upper bound of Dᵢₙₙ, third-dimensional data of UB represents an upper bound of tₛ, and fourth-dimensional data of UB represents an upper bound of h; and
S1.4: transforming the objective function shown by formula (1) with the vector X to obtain a final objective function which is expressed by formula (15):

F(X)=0.07075π((X¹)²−(X²)²)X³ (15)
Where X¹ represents first-dimensional data of the vector X, X² represents second-dimensional data of the vector X, X³ represents third-dimensional data of the vector X, and (·)² represents a square operation of data, that is, (X¹)₂ represents a square operation of X¹, and (X²)² represents a square operation of X².

Solving the key parameters by means of the random unit permutation-based Harris Hawks optimization to obtain the key parameters for weight optimization of the disc spring in S2 specifically comprises:
S2.1: performing population initialization to obtain an initial population: making the vector X correspond to individuals of a population, wherein the individuals have four dimensions, first-dimensional data of the individuals corresponds to Dₒₜ, second-dimensional data of the individuals corresponds to Dᵢₙₙ, third-dimensional data of the individuals corresponds to tₛ, and fourth-dimensional data of the individuals corresponds to h; setting a population capacity N corresponding to the random unit permutation-based Harris Hawks optimization to 30, randomly initializing 30 individuals according to formula (16) to obtain the initial population:

$$\begin{matrix}Pop = \begin{matrix}[ \begin{matrix}{LB}_{1}^{1} & … & {LB}_{1}^{0} \\ ⋮ & … & ⋮ \\ {LB}_{N}^{1} & … & {LB}_{N}^{D}\end{matrix} ] + \\ [ \begin{matrix}{rand}_{1}^{1} & … & {rand}_{1}^{D} \\ ⋮ & … & ⋮ \\ {rand}_{N}^{1} & … & {rand}_{N}^{D}\end{matrix} ] ∘ [ \begin{matrix}{UB}_{1} - {LB}_{1} \\ ⋮ \\ {UB}_{N} - {LB}_{N}\end{matrix} ]\end{matrix} \\ = [ \begin{matrix}{X}_{1}^{1} & … & {X}_{1}^{D} \\ ⋮ & … & ⋮ \\ {X}_{N}^{1} & … & {X}_{N}^{D}\end{matrix} ] = [ \begin{matrix}{X}_{1} \\ ⋮ \\ {X}_{N}\end{matrix} ]\end{matrix} \qquad ( 16 )$$

Where, LBᵢᵢ^{j} represents a lower bound of j^{th}-dimensional data of the (ii)^{th} individual; randᵢᵢ^{j} represents the j^{th}-dimensional data of the (ii)^{th} individual generated by a random function, which is within [0,1]; ° represents a Hadmard product operator of a matrix, that is, elements at the same position of the matrix are multiplied; UBᵢᵢ=UB, LBᵢᵢ=LB, and Xᵢᵢ represents the (ii)^{th} individual of the initial population; Xᵢᵢ=[Xᵢᵢ¹, Xᵢᵢ², Xᵢᵢ³, Xᵢᵢ⁴], Xᵢᵢ^{j} represents the j^{th}-dimensional data of the (ii)^{th} individual, ii=1, 2, . . . , 30, and j=1, 2, 3, 4;
S2.2: evaluating the initial population: calculating an objective function value of each individual in the initial population according to the objective function shown by formula (15), and determining each individual in the initial population according to the constraints in formula (2) to formula (8); if the current individual fails to meet all the constraints, updating this individual by randomly reassigning each of the dimensional data, within a range of the upper bound and the lower bound corresponding to each of the dimensional data, of the individual, and after the current individual is updated, directly setting the objective function value of this individual to 10¹⁰ rather than calculating the objective function value of this individual by formula (15); if the current individual meets all the constraints, keeping this individual unchanged, such that a 0-generation population is obtained; denoting the individual having a minimum objective function value among all individuals meeting all the constraints in the 0-generation population as gBest, denoting the objective function value of the individual gBest as F(gBest), setting a global optimal individual of the (ii)^{th} individual, and denoting the global optimal individual of the (ii)^{th} individual as pBestᵢᵢ; initializing the value of pBestᵢᵢ with Xᵢᵢ in the 0-generation population, and denoting an objective function value of pBestᵢᵢ as F(pBestᵢᵢ);
S2.3: setting an iteration variable t, a maximum iteration T, initializing the iteration variable t to 1, and setting the maximum iteration T to 1000;
S2.4: performing a t^{th} iteration on the population to obtain a t-generation population, which specifically comprises:
S2.4.1: setting an individual number i, and initializing the individual number i to 1;
S2.4.2: updating an i^{th} individual to obtain the i^{th} individual Xᵢ(t) of the t-generation population, which specifically comprises:
S2.4.2.1: setting an energy factor for the t^{th} iteration of the i^{th} individual, and calculating the energy factor for the t^{th} iteration of the individual, which is used for switching a search mode of the algorithm:

$${E}_{f}^{{t}^{i}} = 2 {E}_{0}^{{t}^{i}} \cdot ( 1 - \frac{t}{T} ) \qquad ( 17 )$$

Where, E₀^{t}^{ⁱ} represents a random number for the t^{th} iteration of the i^{th} individual and is generated by a random function, −1≤E₀^{t}^{ⁱ}≤1;
S2.4.2.2: if |E_{f}^{t}^{ⁱ}|<1, performing S2.4.2.3; if |E_{f}^{t}^{ⁱ}|≥1, setting the value of Xᵢ(t) to Xᵢ(t−1), then performing S2.4.2.4, where Xᵢ(t−1) is an i^{th} individual of a (t−1)-generation population, and | | is an absolute value sign;
S2.4.2.3: generating a random number q^{t}^{ⁱ} by the random function, wherein 0≤q^{t}^{ⁱ}≤1; if q^{t}^{ⁱ}≥0.5 and |E_{f}^{t}^{ⁱ}|≥0.5, updating the i^{th} individual according to formula (18) to obtain Xᵢ(t); if q^{t}^{ⁱ}≤0.5 and |E_{f}^{t}^{ⁱ}|≥0.5, updating the i^{th} individual according to formula (23) to obtain Xᵢ(t); if q^{t}^{ⁱ}≥0.5 and |E_{f}^{t}^{ⁱ}|<0.5, updating the i^{th} individual according to formula (24) to obtain Xᵢ(t); if q^{t}^{ⁱ}<0.5 and |E_{f}^{t}^{ⁱ}|<0.5, updating the i^{th} individual according to formula (28) to obtain Xᵢ(t); after Xᵢ(t) is obtained according to formula (18), (23), (24) or (28), calculating an objective function value of Xᵢ(t) according to formula (15); if the objective function value of Xᵢ(t) is less than an objective function value of Xᵢ(t−1), remaining Xᵢ(t) unchanged; if the objective function value of Xᵢ(t) is greater than the objective function value of Xᵢ(t−1), updating Xᵢ(t) to Xᵢ(t−1), substituting data of Xᵢ(t) into formula (2) to formula (8), and determining whether Xᵢ(t) meets the constraints in formula (2) to formula (8); if so, remaining Xᵢ(t) unchanged; otherwise, updating Xᵢ(t) again, reassigning each of the dimensional data, within a range of the upper bound and the lower bound corresponding to each of the dimensional data, of Xᵢ(t), and after Xᵢ(t) is updated, directly setting the objective function value F(Xᵢ(t)) of Xᵢ(t) to 10¹⁰ rather than calculating the objective function value F(Xᵢ(t)) according to formula (15);

$${X}_{i} ( t ) = g Best - {X}_{i} ( t - 1 ) - {E}_{f}^{{t}^{i}} \vert ( {J}^{{t}^{i}} \cdot g Best - {X}_{i} ( t - 1 ) ) \vert \qquad ( 18 )$$

$${J}^{{t}^{i}} = 2 ( 1 - {r}_{1}^{{t}^{i}} ) \qquad ( 19 )$$

$${A}^{{t}^{i}} = g Best - {E}_{f}^{{t}^{i}} \vert {J}^{{t}^{i}} \cdot g Best - {X}_{i} ( t - 1 ) \vert \qquad ( 20 )$$

$${B}^{{t}^{i}} = {A}^{{t}^{i}} + {R}^{{t}^{i}} ° LF ( D ) \qquad ( 21 )$$

$$LF ( D ) = \frac{{r}_{2}^{{t}^{i}} \times σ}{{\vert {r}_{3}^{{t}^{i}} \vert}^{θ}} , σ = {( \frac{Γ ( 1 + θ ) \times sin ( \frac{πθ}{2} )}{Γ ( \frac{1 + θ}{2} ) \times θ \times {2}^{( \frac{θ - 1}{2} )}} )}^{\frac{1}{θ}} \qquad ( 22 )$$

$${X}_{i} ( t ) = \{ \begin{matrix}{A}^{{t}^{i}} & if F ( {A}^{{t}^{i}} ) < F ( {B}^{{t}^{i}} ) \\ {B}^{{t}^{i}} & if F ( {A}^{{t}^{i}} ) \geq F ( {B}^{{t}^{i}} )\end{matrix} \qquad ( 23 )$$

$${X}_{i} ( t ) = g Best - {E}_{f}^{{t}^{i}} \vert g Best - {X}_{i} ( t - 1 ) \vert \qquad ( 24 )$$

$${Y}^{{t}^{i}} = g Best - {E}_{f}^{{t}^{i}} \vert {J}^{{t}^{i}} \cdot g Best - {Mean}^{{t}^{i}} \vert \qquad ( 25 )$$

$${Mean}^{{t}^{i}} = \frac{1}{N} {\sum }_{num = 1}^{N} {X}_{num} ( t - 1 ) \qquad ( 26 )$$

$${Z}^{{t}^{i}} = {Y}^{{t}^{i}} + {R}^{{t}^{i}} ° LF ( D ) \qquad ( 27 )$$

$${X}_{i} ( t ) = \{ \begin{matrix}{Y}^{{t}^{i}} & if F ( {Y}^{{t}^{i}} ) < F ( {Z}^{{t}^{i}} ) \\ {Z}^{{t}^{i}} & if F ( {Y}^{{t}^{i}} ) \geq F ( {Z}^{{t}^{i}} )\end{matrix} \qquad ( 28 )$$

Where, Xᵢ(t) represents the i^{th} individual of the t-generation population, A^{t}^{ⁱ}, B^{t}^{ⁱ}, Y^{t}^{ⁱ}, Z^{t}^{ⁱ} represent four intermediate individuals generated for the i^{th} individual during the t^{th} iteration, | | represents an absolute value sign, the value of θ is 1.5, r₁^{t}^{ⁱ} represents a first one-row D-dimensional random number vector generated for the i^{th} individual by the t^{th} iteration, each of the dimensional data of the first one-row D-dimensional random number vector has a lower bound 0 and an upper bound 1, r₂^{t}^{ⁱ} represents a second one-row D-dimensional random number vector generated for the i^{th} individual by the t^{th} iteration, each of the dimensional data of the second one-row D-dimensional random number vector has a lower bound 0 and an upper bound 1, r₃^{t}^{ⁱ} represents a third one-row D-dimensional random number vector generated for the i^{th} individual by the i^{th} iteration, each of the dimensional data of the third one-row D-dimensional random number vector has a lower bound 0 and an upper bound 1, J^{t}^{ⁱ} represents a random number generated for the i^{th} individual by the t^{th} iteration and is used for disturbing a current optimal individual to improve the diversity of the population, LF is a levy flight function, Mean^{t}^{ⁱ} represents a mean value of X₁(t−1), X²(t−1), . . . , X_{N}(t−1) when the i^{th} individual is solved by the t^{th} iteration, and is expressed by formula (26), Γ is a gamma function, R^{t}^{ⁱ} represents the one-column D-dimensional random number vector generated for i^{th} individual by the t^{th} iteration, and each of the dimensional data of the one-column D-dimensional random number vector has a lower bound 0 and an upper bound 1; if the objective function value F(Xᵢ(t)) of Xᵢ(t) is set to 10¹⁰, the objective function value F(Xᵢ(t)) of Xᵢ(t) is obtained directly; if the objective function value F(Xᵢ(t)) of Xᵢ(t) is not set to 10¹⁰, the objective function value F(Xᵢ(t)) of Xᵢ(t) is calculated according to formula (15); then, if F(Xᵢ(t))<F(gBest), a variable value of gBest is updated to Xᵢ(t); otherwise, the variable value of gBest is not updated; if F(Xᵢ(t))<F(pBestᵢ), a variable value of pBestᵢ is updated to Xᵢ(t); otherwise, the variable value of pBestᵢ is not updated; up to now, Xᵢ(t) is updated, and S2.4.2.4 is performed;
S2.4.2.4: setting four intermediate individuals M1^{t}^{ⁱ}, M2^{t}^{ⁱ}, SM1^{t}^{ⁱ} and SM2^{t}^{ⁱ}, and calculating M1^{t}^{ⁱ} and M2^{t}^{ⁱ} according to formula (29) and formula (30);

$$M {1}^{{t}^{i}} = {k}_{1}^{{t}^{i}} \cdot ( {k}_{2}^{{t}^{i}} \cdot {X}_{{a}_{1}^{{t}^{i}}} ( t - 1 ) + ( ∼ {k}_{2}^{{t}^{i}} ) \cdot {X}_{{a}_{2}^{{t}^{i}}} ( t - 1 ) ) + ( ∼ {k}_{1}^{{t}^{i}} ) \cdot g Best \qquad ( 29 )$$

$$M {2}^{{t}^{i}} = {k}_{1}^{{t}^{i}} \cdot ( {k}_{2}^{{t}^{i}} \cdot {X}_{{a}_{3}^{{t}^{i}}} ( t - 1 ) + ( ∼ {k}_{2}^{{t}^{i}} ) \cdot {X}_{{a}_{4}^{{t}^{i}}} ( t - 1 ) ) + ( ∼ {k}_{1}^{{t}^{i}} ) \cdot gBest \qquad ( 30 )$$

Where k₁^{t}^{ⁱ} is a one-row D-dimensional random number vector generated by the random function, and each of the dimensional data of the one-row D-dimensional random number vector has a lower bound 0 and an upper bound 1; is a one-row D-dimensional random number vector generated by the random function, and each of the dimensional data of the one-row D-dimensional random number vector has a lower bound 0 and an upper bound 1; ˜ is a bitwise negation operator; the values of a₁^{t}^{ⁱ}, a₂^{t}^{ⁱ}, a₃^{t}^{ⁱ}, a₄^{t}^{ⁱ} are four different integers within [1, N] except i;
Substituting M1^{t}^{ⁱ} and M2^{t}^{ⁱ} into formula (31) and formula (32) respectively to obtain SM1^{t}^{ⁱ} and SM2^{t}^{ⁱ}:

$$SM {1}^{{t}^{i}} = M {1}^{{t}^{i}} + 2 \cdot {r}_{4}^{{t}^{i}} \cdot {e}^{F ( gBest ) - F ( {X}_{i} ( t ) )} ° ( gBest - {X}_{i} ( t - 1 ) ) + {r}_{5}^{{t}^{i}} ° ( gBest - {pBest}_{i} ) \qquad ( 31 )$$

$$SM {2}^{{t}^{i}} = M {2}^{{t}^{i}} + 2 \cdot {r}_{6}^{{t}^{i}} \cdot {e}^{gBest - {X}_{i} ( t )} ° ( gBest - {X}_{i} ( t ) ) + {r}_{7}^{{t}^{i}} ° ( gBest - {X}_{i} ( t - 1 ) ) \qquad ( 32 )$$

Where r₄^{t}^{ⁱ} a one-row D-dimensional random number vector generated by the random function, and each of the dimensional data of the one-row D-dimensional random number vector has a lower bound 0 and an upper bound 1; r₅^{t}^{ⁱ} is a one-row D-dimensional random number vector generated by the random function, and each of the dimensional data of the one-row D-dimensional random number vector has a lower bound 0 and an upper bound 1; r₆^{t}^{ⁱ} is a random number generated by the random function, and −1≤r₆^{t}^{ⁱ}≤1; r₇^{t}^{ⁱ} is a random function generated by the random function, and −1≤r₇^{t}^{ⁱ}≤1; e is a Napierian constant, the value of e is 2.718281828459045;
Substituting data of SM1^{t}^{ⁱ} and data of SM2^{t}^{ⁱ} into formula (2) and formula (8) respectively; determining whether SM1^{t}^{ⁱ} and SM2^{t}^{ⁱ} meet the constraints in formula (2) to formula (8); if either SM1^{t}^{ⁱ} or SM2^{t}^{ⁱ} fails to meet all the constraints, updating the intermediate individual (SM1^{t}^{ⁱ} or SM2^{t}^{ⁱ}) not meeting all the constraints, and reassigning each of the dimensional data of, between a range of the upper bound and the lower bound corresponding to each of the dimensional data, the individual, and directly setting an objective function value of this individual to 10¹⁰, which is then substituted into formula (33) to obtain an intermediate individual Q^{t}^{ⁱ}; if SM1^{t}^{ⁱ} and SM2^{t}^{ⁱ} both meet all the constraints, directly substituting SM1^{t}^{ⁱ} and SM2^{t}^{ⁱ} into formula (33) to obtain the intermediate individual Q^{t}^{ⁱ}:

$${Q}^{{t}^{i}} = \{ \begin{matrix}SM {1}^{{t}^{i}} , & if F ( SM {1}^{{t}^{i}} ) < F ( SM {2}^{{t}^{i}} ) \\ SM {2}^{{t}^{i}} , & else\end{matrix} \qquad ( 33 )$$

S2.4.2.5: updating Xᵢ(t) to Q^{t}^{ⁱ}; calculating the objective function value of Xᵢ(t) according to formula (15); if the objective function value of Xᵢ(t) is less than the objective function value of gBest, updating the objective function value of gBest to Xᵢ(t); otherwise, not updating the objective function value of gBest; if the objective function of Xᵢ(t) is less than the objective function value of pBestᵢ, updating pBestᵢ to Xᵢ(t); otherwise, not updating pBestᵢ;
S2.4.3: determining whether a current value of i is equal to N; if the current value of i is not equal to N, updating the current value of i to the sum of the current value of i and 1, and then returning to S2.4.2 to update the next individual; if the current value of i is equal to N, completing the t^{th} iteration to obtain N individuals Xᵢ(t) to X_{N}(t) of the t-generation population, and performing the next step;
S2.4.4: determining whether a current value of t is equal to T; if the current value of t is not equal to T, updating the current value of t to the sum of the current value of t and 1, and then returning to S2.4 to perform the next iteration; if the current value of t is equal to T, performing the next step; and
S2.5: outputting the current gBest, and using the current gBest as the key parameters for weight optimization of the disc spring.

Simulation results of the method for optimizing the weight of the disc spring are shown in FIGURE. It can be known, based upon FIGURE, that the method for optimizing the weight of the disc spring has high in convergence rate and optimization precision, can solve key parameters for weight optimization of disc springs under the condition of meeting all constraints, so compared with traditional methods, the weight optimization effect of the disc spring is remarkably improved; and the random unit permutation mechanism adopted by the invention can enhance the diversity of populations, thus improving the probability of finding an optimal search space; and the method provided by the invention can reliably solve the problem of weight optimization of disc springs.

What is claimed is:

1. A method for optimizing a weight of a disc spring comprising steps:
S1: determining an objective function for weight optimization of the disc spring and key parameters to be solved; and
S2: optimizing a structure of an original Harris Hawks optimization, wherein first, eliminating steps of centralized calculation of objective function values in the original Harris Hawks optimization except a step of population initialization, and recording a result when a better solution is obtained, to save calculation time; second, introducing a random unit permutation mechanism before an end of each iterative optimization of the original Harris Hawks optimization to enhance global search performance; third, deleting a step of searching for an energy factor E with an absolute value greater than or equal to 1 in the original Harris Hawks optimization to reduce an influence of the random unit permutation mechanism on an optimization effect; referring to an optimized Harris Hawks optimization as a random unit permutation-based Harris Hawks optimization, and solving the key parameters by means of the random unit permutation-based Harris Hawks optimization to obtain the key parameters for weight optimization of the disc spring.

2. A method for optimizing the weight of the disc spring according to claim 1, wherein determining the objective function for weight optimization of the disc spring and the key parameters to be solved in S1 comprises steps:
S1.1: determining the objective function for weight optimization of the disc spring, wherein the objective function is shown by formula (1):
$$F ( x ) = ρ {V}_{BS} = ρ \cdot \frac{π}{4} \cdot ( {{D}_{ot}}^{2} - {{D}_{inn}}^{2} ) {t}_{s} , \qquad ( 1 )$$
where F(x) is the objective function and represents a weight of the disc spring and is measured by pound (lb); ρ represents a density of the disc spring and is measured by pound/cubic inch (lb/in³); V_{BS} is a size of the disc spring and is measured by cubic inch (in³); π is a circular constant; Dₒₜ is an outer diameter of the disc spring and is measured by inch (in); Dᵢₙₙ is an inner diameter of the disc spring and is measured by inch (in); tₛ is a thickness of the disc spring and is measured by inch (in);
S1.2: determining constraints for weight optimization of the disc spring, wherein the constraints are shown by formula (2) to formula (8):
$${g}_{1} ( x ) = S - \frac{4 E {δ}_{max}}{( 1 - {μ}^{2} ) α {{D}_{ot}}^{2}} [ β ( h - \frac{{δ}_{max}}{2} ) + γ {t}_{s} ] \geq 0 , \qquad ( 2 )$$
$${g}_{2} ( x ) = \frac{4 E {δ}_{max}}{( 1 - {μ}^{2} ) α {{D}_{ot}}^{2}} [ ( h - \frac{{δ}_{max}}{2} ) ( h - {δ}_{max} ) {t}_{s} + {{t}_{s}}^{3} ] - {P}_{max} \geq 0 , \qquad ( 3 )$$
$${g}_{3} ( x ) = {δ}_{l} - {δ}_{max} \geq 0 , \qquad ( 4 )$$
$${g}_{4} ( x ) = H - h - {t}_{s} \geq 0 , \qquad ( 5 )$$
$${g}_{5} ( x ) = {D}_{max} - {D}_{ot} \geq 0 , \qquad ( 6 )$$
$${g}_{6} ( x ) = {D}_{ot} - {D}_{inn} \geq 0 , \qquad ( 7 )$$
$${g}_{7} ( x ) = 0.3 - \frac{h}{{D}_{ot} - {D}_{inn}} \geq 0 , \qquad ( 8 )$$
where g₁(x) is a stress constraint induced by radial compression of the disc spring, g₂(x) is a rigidity constraint of the disc spring, g₃(x) is a limited deflection constraint of the disc spring, g₄(x) is a thickness-height relation constraint of the disc spring, g₅(x) is an outer diameter constraint of the disc spring, g₆(x) is a diameter relation constraint of the disc spring, and g₇(x) is a geometric size constraint of the disc spring, h represents a height of the disc spring, which is measured by inch (in); S represents allowable strength of the disc spring and is measured by kilopound/square inch (kpsi); E represents an elastic modulus of the disc spring and is measured by pound/square inch (psi); δₘₐₓ represents a maximum deflection of the disc spring and is measured by inch (in); μ is a Poisson's ratio of the disc spring; Pₘₐₓ represents a maximum load of the disc spring and is measured by pound (lb); H is a maximum limit of the height of the disc spring and is measured by inch (in); Dₘₐₓ is a maximum outer diameter of the disc spring and is measured by inch (in); δₗ is limited deflection, δₗ=f(a)h;
$$a = \frac{h}{{t}_{s}}$$
represents a ratio of the height of the disc spring to the thickness of the disc spring; f(a) represents load deformation of the disc spring and is measured by inch (in); K=Dₒₜ/Dᵢₙₙ, and α, β and γ are temporary variables and are calculated by formula (9) to formula (11):
$$α = \frac{6}{π ln K} {( \frac{K - 1}{K} )}^{2} , \qquad ( 9 )$$
$$β = \frac{6}{π ln K} ( \frac{K - 1}{ln K} - 1 ) , \qquad ( 10 )$$
$$γ = \frac{6}{πln K} ( \frac{K - 1}{2} ) ; \qquad ( 11 )$$
S1.3: determining parameter values in the constraints shown by formula (2) to formula (8), where ρ=0.283 lb/in³, S=200 kpsi, E=30×10⁶ psi, δₘₐₓ=0.2 in, μ=0.3, Pₘₐₓ=5400 lb, H=2 in, Dₘₐₓ=12.01 in, and the relation between a and f(a) is as follows: when a<1.45, f(a)=1; when 1.45≤a<1.55, f(a)=0.85; when 1.55≤a<1.65, f(a)=0.77; when 1.65≤a<1.75, f(a)=0.71; when 1.75≤a<1.85, f(a)=0.66; when 1.85≤a<1.95, f(a)=0.63; when 1.95≤a<2.05, f(a)=0.6; when 2.05≤a<2.15, f(a)=0.58; when 2.15≤a<2.25, f(a)=0.56; when 2.25≤a<2.35, f(a)=0.55; when 2.35≤a<2.45, f(a)=0.53; when 2.45≤a<2.55, f(a)=0.52; when 2.55≤a<2.65, f(a)=0.51; when 2.65≤a<2.75, f(a)=0.51; when a≥2.75, f(a)=0.50; the outer diameter Dₒₜ of the disc spring, the inner diameter Dᵢₙₙ of the disc spring, the thickness tₛ of the disc spring, and the height h of the disc spring, are the key parameters to be solved, and 5 in≤D Dₒₜ≤15 in, 5 in≤Dᵢₙₙ≤15 in, 0.01 in≤tₛ≤6 in, and 0.05 in≤h≤0.5 in; the key parameters to be solved are represented by a vector X, where a lower bound of X is represented by a vector LB, an upper bound of X is represented by a vector UB, and X, LB and UB are expressed by formula (12) to formula (14):
X=[Dₒₜ,Dᵢₙₙ,tₛ,h] (12)
LB=[5,5,0.01,0.05] (13)
UB=[15,15,6,0.5] (14)
where first-dimensional data of LB represents a lower bound of Dₒₜ, second-dimensional data of LB represents a lower bound of Dᵢₙₙ, third-dimensional data of LB represents a lower bound of tₛ, fourth-dimensional data of LB represents a lower bound of h, first-dimensional data of UB represents an upper bound of Dₒₜ, second-dimensional data of UB represents an upper bound of Dᵢₙₙ, third-dimensional data of UB represents an upper bound of tₛ, and fourth-dimensional data of UB represents an upper bound of h; and
S1.4: transforming the objective function shown by formula (1) with the vector X to obtain a final objective function which is expressed by formula (15):
F(X)=0.07075π((X¹)²−(X²)²)X³ (15)
where X¹ represents first-dimensional data of the vector X, X² represents second-dimensional data of the vector X, X³ represents third-dimensional data of the vector X, (X¹)₂ represents a square operation of X¹, and (X²)² represents a square operation of X².

3. A method for optimizing the weight of the disc spring according to claim 2, wherein solving the key parameters by means of the random unit permutation-based Harris Hawks optimization to obtain the key parameters for weight optimization of the disc spring in S2 comprises:
S2.1: performing population initialization to obtain an initial population: making the vector X correspond to individuals of a population, wherein the individuals have four dimensions, first-dimensional data of the individuals corresponds to Dₒₜ, second-dimensional data of the individuals corresponds to Dᵢₙₙ third-dimensional data of the individuals corresponds to tₛ, and fourth-dimensional data of the individuals corresponds to h; setting a population capacity N corresponding to the random unit permutation-based Harris Hawks optimization to 30, randomly initializing 30 individuals according to formula (16) to obtain the initial population:
$$\begin{matrix}Pop = [ \begin{matrix}{LB}_{1}^{1} & ⋯ & {LB}_{1}^{D} \\ ⋮ & ⋯ & ⋮ \\ {LB}_{N}^{1} & ⋯ & {LB}_{N}^{D}\end{matrix} ] + [ \begin{matrix}{rand}_{1}^{1} & ⋯ & {rand}_{1}^{D} \\ ⋮ & ⋯ & ⋮ \\ {rand}_{N}^{1} & ⋯ & {rand}_{N}^{D}\end{matrix} ] ° [ \begin{matrix}{UB}_{1} - {LB}_{1} \\ ⋮ \\ {UB}_{N} - {LB}_{N}\end{matrix} ] \\ = [ \begin{matrix}{X}_{1}^{1} & ⋯ & {X}_{1}^{D} \\ ⋮ & ⋯ & ⋮ \\ {X}_{N}^{1} & ⋯ & {X}_{N}^{D}\end{matrix} ] = [ \begin{matrix}{X}_{1} \\ ⋮ \\ {X}_{N}\end{matrix} ]\end{matrix} , \qquad ( 16 )$$
where LBᵢᵢ^{j} represents a lower bound of j^{th}-dimensional data of an (ii)^{th} individual; randᵢᵢ^{j} represents the j^{th}-dimensional data of the (ii)^{th} individual generated by a random function and is within [0,1]; ° represents a Hadmard product operator of a matrix; UBᵢᵢ=UB, LBᵢᵢ=LB, and Xᵢᵢ represents the (ii)^{th} individual of the initial population; Xᵢᵢ=[Xᵢᵢ¹, Xᵢᵢ², Xᵢᵢ³, Xᵢᵢ⁴], Xᵢᵢ^{j} represents the j^{th}-dimensional data of the (ii)^{th} individual, ii=1, 2, . . . , 30, and j=1, 2, 3, 4;
S2.2: evaluating the initial population: calculating an objective function value of each of the individuals in the initial population according to the objective function shown by formula (15), and determining each of the individuals in the initial population according to the constraints in formula (2) to formula (8); if a current individual within the individuals fails to meet all of the constraints, updating the current individual by randomly reassigning each of dimensional data, within an upper bound and a lower bound corresponding to each of the dimensional data, of the current individual, and after the current individual is updated, directly setting an objective function value of the current individual to 10¹⁰ rather than calculating the objective function value of the current individual by formula (15); if the current individual meets all of the constraints, keeping the current individual unchanged, such that a 0-generation population is obtained; denoting an individual having a minimum objective function value among all of the individuals meeting all of the constraints in the 0-generation population as gBest, denoting an objective function value of the individual gBest as F(gBest), setting a global optimal individual of the (ii)^{th} individual, and denoting a global optimal individual of the (ii)^{th} individual as pBestᵢᵢ; initializing a value of pBestᵢᵢ with Xᵢᵢ in the 0-generation population, and denoting an objective function value of pBestᵢᵢ as F(pBestᵢᵢ);
S2.3: setting an iteration variable t, a maximum iteration T, initializing the iteration variable t to 1, and setting the maximum iteration T to 1000;
S2.4: performing a t^{th} iteration on the 0-generation population to obtain a t-generation population, comprising steps:
S2.4.1: setting an individual number i, and initializing the individual number i to 1;
S2.4.2: updating an i^{th} individual to obtain an i^{th} individual Xᵢ(t) of the t-generation population, comprising steps:
S2.4.2.1: setting an energy factor for the t^{th} iteration of the i^{th} individual, and calculating the energy factor for the t^{th} iteration of the i^{th} individual, which is used for switching a search mode of a algorithm:
$${E}_{f}^{{t}^{i}} = 2 {E}_{0}^{{t}^{i}} \cdot ( 1 - \frac{t}{T} ) , \qquad ( 17 )$$
where E₀^{t}^{ⁱ} represents a random number for the t^{th} iteration of the i^{th} individual and is generated by a random function, −1≤E₀^{t}^{ⁱ}≤1;
S2.4.2.2: if |E_{f}^{t}^{ⁱ}|<1, performing S2.4.2.3; if |E_{f}^{t}^{ⁱ}|≥1, setting a value of Xᵢ(t) to Xᵢ(t−1), then performing S2.4.2.4, where Xᵢ(t−1) is an i^{th} individual of a (t−1)-generation population;
S2.4.2.3: generating a random number q^{t}^{ⁱ} by the random function, wherein 0≤q^{t}^{ⁱ}≤1; if q^{t}^{ⁱ}≥0.5 and |E_{f}^{t}^{ⁱ}|≥0.5, updating the i^{th} individual according to formula (18) to obtain Xᵢ(t); if q^{t}^{ⁱ}<0.5 and |E_{f}^{t}^{ⁱ}|≥0.5, updating the i^{th} individual according to formula (23) to obtain Xᵢ(t); if q^{t}^{ⁱ}≥0.5 and |E_{f}^{t}^{ⁱ}|<0.5, updating the i^{th} individual according to formula (24) to obtain Xᵢ(t); if q^{t}^{ⁱ}<0.5 and |E_{f}^{t}^{ⁱ}|<0.5, updating the i^{th} individual according to formula (28) to obtain Xᵢ(t); after Xᵢ(t) is obtained according to formula (18), (23), (24) or (28), calculating an objective function value of Xᵢ(t) according to formula (15); if the objective function value of Xᵢ(t) is less than an objective function value of Xᵢ(t−1), remaining Xᵢ(t) unchanged; if the objective function value of Xᵢ(t) is greater than the objective function value of Xᵢ(t−1), updating Xᵢ(t) to Xᵢ(t−1), substituting data of Xᵢ(t) into formula (2) to formula (8), and determining whether Xᵢ(t) meets the constraints in formula (2) to formula (8); if so, remaining Xᵢ(t) unchanged; otherwise, updating Xᵢ(t) again, reassigning each of dimensional data, within an upper bound and a lower bound corresponding to each of the dimensional data, of Xᵢ(t), and after Xᵢ(t) is updated, directly setting the objective function value of Xᵢ(t), denoting F(Xᵢ(t)), to 10¹⁰ rather than calculating the objective function value F(Xᵢ(t)) according to formula (15);
$${X}_{i} ( t ) = g Best - {X}_{i} ( t - 1 ) - {E}_{f}^{{t}^{i}} \vert ( {J}^{{t}^{i}} \cdot g Best - {X}_{i} ( t - 1 ) ) \vert , \qquad ( 18 )$$
$${J}^{{t}^{i}} = 2 ( 1 - {r}_{1}^{{t}^{i}} ) , \qquad ( 19 )$$
$${A}^{{t}^{i}} = g Best - {E}_{f}^{{t}^{i}} \vert {J}^{{t}^{i}} \cdot g Best - {X}_{i} ( t - 1 ) \vert , \qquad ( 20 )$$
$${B}^{{t}^{i}} = {A}^{{t}^{i}} + {R}^{{t}^{i}} ° LF ( D ) , \qquad ( 21 )$$
$$LF ( D ) = \frac{{r}_{2}^{{t}^{i}} \times σ}{{\vert {r}_{3}^{{t}^{i}} \vert}^{θ}} , σ = {( \frac{Γ ( 1 + θ ) \times sin ( \frac{πθ}{2} )}{Γ ( \frac{1 + θ}{2} ) \times θ \times {2}^{( \frac{θ - 1}{2} )}} )}^{\frac{1}{θ}} , \qquad ( 22 )$$
$${X}_{i} ( t ) = \{ \begin{matrix}{A}^{{t}^{i}} & if F ( {A}^{{t}^{i}} ) < F ( {B}^{{t}^{i}} ) \\ {B}^{{t}^{i}} & if F ( {A}^{{t}^{i}} ) \geq F ( {B}^{{t}^{i}} )\end{matrix} , \qquad ( 23 )$$
$${X}_{i} ( t ) = g Best - {E}_{f}^{{t}^{i}} \vert g Best - {X}_{i} ( t - 1 ) \vert , \qquad ( 24 )$$
$${Y}^{{t}^{i}} = g Best - {E}_{f}^{{t}^{i}} \vert {J}^{{t}^{i}} \cdot g Best - {Mean}^{{t}^{i}} \vert , \qquad ( 25 )$$
$${Mean}^{{t}^{i}} = \frac{1}{N} {\sum }_{num = 1}^{N} {X}_{num} ( t - 1 ) , \qquad ( 26 )$$
$${Z}^{{t}^{i}} = {Y}^{{t}^{i}} + {R}^{{t}^{i}} ° LF ( D ) , \qquad ( 27 )$$
$${X}_{i} ( t ) = \{ \begin{matrix}{Y}^{{t}^{i}} & if F ( {Y}^{{t}^{i}} ) < F ( {Z}^{{t}^{i}} ) \\ {Z}^{{t}^{i}} & if F ( {Y}^{{t}^{i}} ) \geq F ( {Z}^{{t}^{i}} )\end{matrix} , \qquad ( 28 )$$
where A^{t}^{ⁱ}, B^{t}^{ⁱ}, Y^{t}^{ⁱ}, Z^{t}^{ⁱ} represent four intermediate individuals generated for the i^{th} individual during the t^{th} iteration, a value of θ is 1.5, r₁^{t}^{ⁱ} represents a first one-row D-dimensional random number vector generated for the i^{th} individual by the t^{th} iteration, each of dimensional data of the first one-row D-dimensional random number vector has a lower bound 0 and an upper bound 1, r₂^{t}^{ⁱ} represents a second one-row D-dimensional random number vector generated for the i^{th} individual by the t^{th} iteration, each of dimensional data of the second one-row D-dimensional random number vector has a lower bound 0 and an upper bound 1, r₃^{t}^{ⁱ} represents a third one-row D-dimensional random number vector generated for the i^{th} individual by the t^{th} iteration, each of dimensional data of the third one-row D-dimensional random number vector has a lower bound 0 and an upper bound 1, J^{t}^{ⁱ} represents a random number generated for the i^{th} individual by the t^{th} iteration and is used for disturbing a current optimal individual, LF is a levy flight function, Mean^{t}^{ⁱ} represents a mean value of X₁(t−1), X₂(t−1), . . . , X_{N}(t−1) when the i^{th} individual is solved by the t^{th} iteration, and is expressed by formula (26), Γ is a gamma function, R^{t}^{ⁱ} represents a one-column D-dimensional random number vector generated for i^{th} individual by the t^{th} iteration, and each of dimensional data of the one-column D-dimensional random number vector has a lower bound 0 and an upper bound 1; if the objective function value F(Xᵢ(t)) of Xᵢ(t) is set to 10¹⁰, the objective function value F(Xᵢ(t)) of Xᵢ(t) is obtained directly; if the objective function value F(Xᵢ(t)) of Xᵢ(t) is not set to 10¹⁰, the objective function value F(Xᵢ(t)) of Xᵢ(t) is calculated according to formula (15); if F(Xᵢ(t))<F(gBest), a variable value of gBest is updated to Xᵢ(t); otherwise, the variable value of gBest is not updated; if F(Xᵢ(t))<F(pBestᵢ), a variable value of pBestᵢ is updated to Xᵢ(t); otherwise, the variable value of pBestᵢ is not updated; up to now, Xᵢ(t) is updated, and S2.4.2.4 is performed;
S2.4.2.4: setting four intermediate individuals M1^{t}^{ⁱ}, M2^{t}^{ⁱ}, SM1^{t}^{ⁱ} and SM2^{t}^{ⁱ}, and calculating M1^{t}^{ⁱ} and M2^{t}^{ⁱ} according to formula (29) and formula (30);
$$M {1}^{{t}^{i}} = {k}_{1}^{{t}^{i}} \cdot ( {k}_{2}^{{t}^{i}} \cdot {X}_{{a}_{1}^{{t}^{i}}} ( t - 1 ) + ( ∼ {k}_{2}^{{t}^{i}} ) \cdot {X}_{{a}_{2}^{{t}^{i}}} ( t - 1 ) ) + ( ∼ {k}_{1}^{{t}^{i}} ) \cdot g Best , \qquad ( 29 )$$
$$M {2}^{{t}^{i}} = {k}_{1}^{{t}^{i}} \cdot ( {k}_{2}^{{t}^{i}} \cdot {X}_{{a}_{3}^{{t}^{i}}} ( t - 1 ) + ( ∼ {k}_{2}^{{t}^{i}} ) \cdot {X}_{{a}_{4}^{{t}^{i}}} ( t - 1 ) ) + ( ∼ {k}_{1}^{{t}^{i}} ) \cdot gBest , \qquad ( 30 )$$
where k₁^{t}^{ⁱ} is a one-row D-dimensional random number vector generated by the random function, and each of dimensional data of the one-row D-dimensional random number vector has a lower bound 0 and an upper bound 1; k₂^{t}^{ⁱ} is a one-row D-dimensional random number vector generated by the random function, and each of dimensional data of the one-row D-dimensional random number vector has a lower bound 0 and an upper bound 1; ˜ is a bitwise negation operator; values of a₁^{t}^{ⁱ}, a₂^{t}^{ⁱ}, a₃^{t}^{ⁱ}, a₄^{t}^{ⁱ} are four different integers within [1, N] except i;
substituting M1^{t}^{ⁱ} and M2^{t}^{ⁱ} into formula (31) and formula (32) respectively to obtain SM1^{t}^{ⁱ} and SM2^{t}^{ⁱ}:
$$SM {1}^{{t}^{i}} = M {1}^{{t}^{i}} + 2 \cdot {r}_{4}^{{t}^{i}} \cdot {e}^{F ( gBest ) - F ( {X}_{i} ( t ) )} ° ( gBest - {X}_{i} ( t - 1 ) ) + {r}_{5}^{{t}^{i}} ° ( gBest - {pBest}_{i} ) , \qquad ( 31 )$$
$$SM {2}^{{t}^{i}} = M {2}^{{t}^{i}} + 2 \cdot {r}_{6}^{{t}^{i}} \cdot {e}^{gBest - {X}_{i} ( t )} ° ( gBest - {X}_{i} ( t ) ) + {r}_{7}^{{t}^{i}} \cdot ( gBest - {X}_{i} ( t - 1 ) ) , \qquad ( 32 )$$
where r₄^{t}^{ⁱ} a one-row D-dimensional random number vector generated by the random function, and each of dimensional data of the one-row D-dimensional random number vector has a lower bound 0 and an upper bound 1; r₅^{t}^{ⁱ} is a one-row D-dimensional random number vector generated by the random function, and each of dimensional data of the one-row D-dimensional random number vector has a lower bound 0 and an upper bound 1; r₆^{t}^{ⁱ} is a random number generated by the random function, and −1≤r₆^{t}^{ⁱ}≤1; r₇^{t}^{ⁱ} is a random function generated by the random function, and −1≤r₇^{t}^{ⁱ}≤1; e is a Napierian constant, a value of e is 2.718281828459045;
substituting data of SM1^{t}^{ⁱ} and data of SM2^{t}^{ⁱ} into formula (2) and formula (8) respectively; determining whether SM1^{t}^{ⁱ} and SM2^{t}^{ⁱ} meet the constraints in formula (2) to formula (8); if one of two intermediate individuals, SM1^{t}^{ⁱ} and SM2^{t}^{ⁱ}, fails to meet all of the constraints, updating the one of the two intermediate individuals not meeting all the constraints, and reassigning each of dimensional data, within an upper bound and a lower bound corresponding to each of the dimensional data, of the one of the two individuals, and directly setting an objective function value of the one of the two intermediate individuals to 10¹⁰, the objective function value of the one of the two intermediate individuals is substituted into formula (33) to obtain an intermediate individual Q^{t}^{ⁱ}; if SM1^{t}^{ⁱ} and SM2^{t}^{ⁱ} both meet all the constraints, directly substituting SM1^{t}^{ⁱ} and SM2^{t}^{ⁱ} into formula (33) to obtain the intermediate individual Q^{t}^{ⁱ}:
$${Q}^{{t}^{i}} = \{ \begin{matrix}SM {1}^{{t}^{i}} , & if F ( SM {1}^{{t}^{i}} ) < F ( SM {2}^{{t}^{i}} ) \\ SM {2}^{{t}^{i}} , & else\end{matrix} \qquad ( 33 )$$
S2.4.2.5: updating Xᵢ(t) to Q^{t}^{ⁱ}; calculating the objective function value of Xᵢ(t) according to formula (15); if the objective function value of Xᵢ(t) is less than the objective function value of gBest, updating the objective function value of gBest to Xᵢ(t); otherwise, not updating the objective function value of gBest; if the objective function of Xᵢ(t) is less than the objective function value of pBestᵢ, updating the objective function value of pBestᵢ to Xᵢ(t); otherwise, not updating the objective function value of pBestᵢ;
S2.4.3: determining whether a current value of i is equal to N; if the current value of i is not equal to N, updating the current value of i to the sum of the current value of i and 1, and then returning to S2.4.2 to update a next individual; if the current value of i is equal to N, completing the t^{th} iteration to obtain N individuals Xᵢ(t) to X_{N}(t) of the t-generation population, and performing a next step;
S2.4.4: determining whether a current value of t is equal to T; if the current value of t is not equal to T, updating the current value of t to the sum of the current value of t and 1, and then returning to S2.4 to perform a next iteration; if the current value of t is equal to T, performing a next step; and
S2.5: outputting a current gBest, and using the current gBest as the key parameters for weight optimization of the disc spring.
